(19) United States
(12) Patent Application Publication
(10) Pub. No.: US 2012/0162362 A1
(43) Pub. Date: Jun. 28, 2012

(54) MAPPING SOUND SPATIALIZATION FIELDS TO PANORAMIC VIDEO

(75) Inventors: Alex Garden, Bellevue, WA (US); Ben Vaught, Seattle, WA (US); Michael Rondinelli, Canonsburg, PA (US)

(73) Assignee: MICROSOFT CORPORATION, Redmond, WA (US)

(21) Appl. No.: 12/976,823

(22) Filed: Dec. 22, 2010

(51) Int. Cl. H04N 13/00; H04N 9/475

(52) U.S. Cl. 348/42; 348/515; 348/E13.001; 348/E09.034

(57) ABSTRACT

Systems and methods are disclosed for mapping a sound spatialization field to a displayed panoramic image as the viewing angle of the panoramic image changes. As the viewing angle of the image data changes, the audio data is processed to rotate the captured sound spatialization field to the same extent. Thus, the audio data remains mapped to the image data whether the image data is rotated about a single axis or about more than one axis.

### BACKGROUND

It is known to map audio to video images for a fixed frame of reference. For example, when a car is displayed to a user on a screen moving from left to right, the audio can be mixed so as to appear to move with the car. The frame of reference is fixed in that the user does not change the viewing angle of the displayed images. Panoramic video systems are also known which simulate immersion of a user within a three-dimensional scene, and which allow a dynamic image frame of reference. Such systems may be experienced by a user over a television, or by a head mounted display unit, which occludes the real world view and instead displays recorded images of the panorama to the user. In such systems, a user may dynamically change their field of view of the panorama to pan left, right, straight ahead, etc. Thus, in the above example, instead of the car moving from left to right in the user's field of view, the user can change the viewing angle of the panorama so that the car remains stationary in the user's field of view (for example centered on the television) while the background panorama changes.

In such instances, a static audio field will not properly track with a change of the viewing angle. The volume of the audio may work properly, for example as the apparent distance between the car of the above example and user's vantage point changes. However, while the user may track the car with the controller to stay stationary in his field of view (for example centered on the television), the audio of the car will appear to move from left to right within the sound field.

### SUMMARY

Disclosed herein are systems and methods for mapping a sound spatialization field to a displayed panoramic image as the viewing angle of the panoramic image changes. In one example, the present technology includes an image capture device and a microphone array for capturing image and audio data of a real person, place or thing. The images captured may be around a 360° panorama, and the microphone array captures a spherical sound spatialization field of the panorama. The audio data may be processed and stored in a variety of multi-channel formats, including for example ambisonic B-format.

A user may thereafter experience the image and audio data via a display and a sound transmitter such as for example an array of loudspeakers. The user has a controller which allows the user to change the view provided on the display to pan to different areas of the captured panoramic image. The image may be changed to rotate at least in a horizontal plane around the panorama, but may also be changed about any of one or more of three orthogonal axes.

As the viewing angle of the image data changes, the present system processes the audio data to rotate the captured sound spatialization field to the same extent. Thus, the audio data remains mapped to the image data whether the image data is rotated about a single axis or about more than one axis.

In one embodiment, the present technology relates to a method of mapping audio data of a real person, place and/or thing to image data of a panorama including the real person, place and/or thing, comprising: (a) processing the image data of the panorama including the real person, place and/or thing to show the image data from a selected viewing angle; and (b) processing audio data of the real person, place and/or thing to map a sound spatialization field of the audio data to align with the selected viewing angle of the image data.

In another embodiment, the present technology relates to a system for presenting panoramic image data and associated audio data from a user-selected perspective, the image and audio data captured from a real person, place and/or thing, the system comprising: a display for displaying images from the panoramic image data; an audio transmitter for providing audio associated with the panoramic image data; a controller for varying of the image data displayed on the display; and a computing device for mapping a sound spatialization field to the panoramic image data so that the audio transmitted by the audio source matches an image displayed by the display.

In a further embodiment, the present technology relates to a computer-readable storage medium for programming a processor to perform a method of mapping audio data of a real person, place and/or thing to image data of a panorama including the real person, place and/or thing, comprising: (a) displaying a first image generated from the image data of a first portion of the panorama including the real person, place or thing; (b) playing audio data to recreate a sound spatialization field aligned in three-dimensions with the image data of the real person place or thing; (c) receiving an indication to change a viewing angle of the image displayed in said step (a); (d) processing the image data to rotate an image displayed about one or more orthogonal axes; (e) displaying a second image generated from the image data of a second portion of the panorama including the real person, place or thing based on processing the image data in said step (d); (f) processing the audio data to rotate the sound spatialization field about the one or more orthogonal axes to the same extent the image was rotated in said step (d); and (g) playing the audio data to recreate the sound spatialization field processed in said step (f).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view of an image capture device for capturing images from a panorama and a microphone array for capturing audio of the panorama.

FIG. 2 is a schematic representation of a user interacting with a system for providing dynamic image and audio data of a panorama.

FIG. 3 is a flowchart for capturing image and audio data of a panorama.

FIG. 4 is a flowchart for displaying image data from variable viewing angles and for providing a sound spatialization field mapped to the selected viewing angle of the image data.

FIG. 5 is a top view of a capture device and microphone array capturing image data and audio data from a panorama.

FIG. 6 is a block diagram for processing ambisonic B-format audio data for playback to loudspeakers according to embodiments of the present system.

FIG. 7 is a top view of a user viewing image data with a viewing angle set to a reference position.

FIG. 8 is a top view of the user receiving audio data with the sound spatialization field mapped to the reference position of the image data of FIG. 7.

FIG. 9 is a top view of a user viewing image data with a viewing angle rotated away from the reference position.

FIG. 10 is a top view of the user receiving audio data with the sound spatialization field mapped to the viewing angle of the image data of FIG. 9.

FIG. 11 is a block diagram for processing ambisonic B-format audio data for playback to binaural sound systems according to embodiments of the present system.

FIG. 12 is a block diagram of a sample computing device on which embodiments of the present system may be implemented.

### DETAILED DESCRIPTION

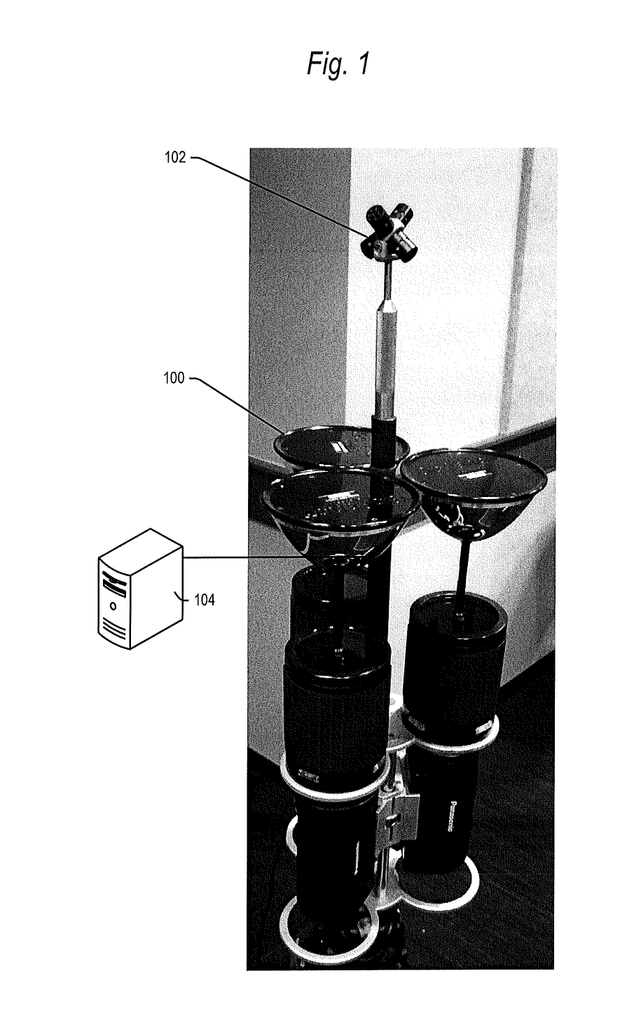

Embodiments of the present technology will now be described with reference to FIGS. 1-12, which in general relate to systems and methods for mapping a sound spatialization field to a displayed panoramic image as the viewing angle of the panoramic image changes. Recent technological advances allow for an immersive, stereoscopic view of a 360° panorama. Such technology is described for example in applicant's co-pending patent application Ser. No. 12/971,580, entitled “System For Capturing Panoramic Stereoscopic Video,” Zargarpour et al., filed Dec. 17, 2010, which application is incorporated by reference herein in its entirety and is referred to herein as the “Panoramic Imaging Application.” The Panoramic Imaging Application describes a system allowing a user to be immersed in a 3D scene, where the user can dynamically change the viewing angle of the scene to look anywhere around 360° of the panorama.

In examples, the images used in the system of the Panoramic Imaging Application may be of real events, people, places or things. As just some non-limiting examples, the images may be of a sporting event or music concert, where the user has the ability to view the event from on the field of play, on the stage or anywhere else the image-gathering cameras are positioned.

The present technology operates in conjunction with the technology described in the Panoramic Imaging Application by recording the audio from the captured scene. Thereafter, as explained below, when the captured images are displayed to the user, the associated audio may be played as well. The present system maps a sound spatialization field to the captured panoramic image. Thus, as a user views the panoramic images from different viewing angles, the sound spatialization field moves with the images.

Humans hear sound in three-dimensions, using for example head related transfer functions (HRTFs) and head motion. As such, in examples, audio may be recorded on multiple channels using multiple recording devices to provide a spatialized effect of a three-dimensional sound spatialization field (“SSF” in the drawings). One method of providing a 3D sound spatialization field is by recording acoustic sources using a technique referred to ambisonics. The ambisonic approach is described for example in the publication by M. A. Gerzon, “Ambisonics in Multichannel Broadcasting and Video,” Journal of the Audio Engineering Society, Vol. 33, No. 11, pp. 859-871 (October, 1985), which publication is incorporated by reference herein in its entirety.

Ambisonic recording is one of a variety of technologies which may be used in the present system for effectively recording sound directions and amplitudes, and reproducing them over loudspeaker systems so that listeners can perceive sounds located in three-dimensional space. In embodiments, the ambisonic system records sound signals in “ambisonic B-format” over four discrete channels. The B-format channel information includes three microphone channels (X, Y, Z), in addition to an omnidirectional channel (W). In further embodiments, audio signals may be recorded using fewer or greater numbers of channels. In one further embodiment, 2D (horizontal-only) 360-degree signals may be recorded using three channels.

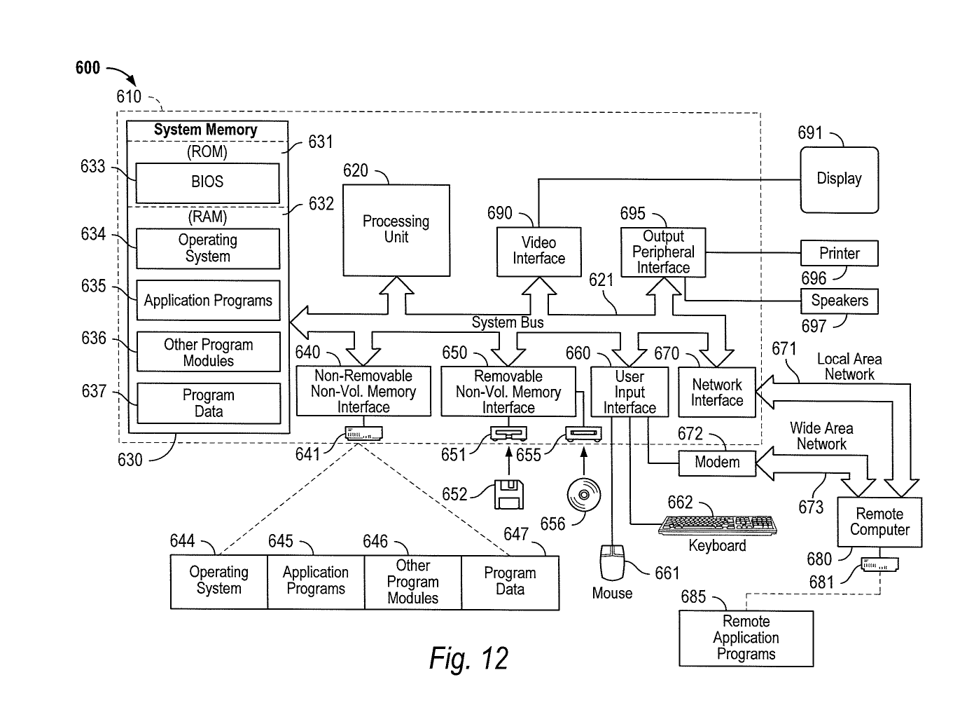

In an embodiment using four channels, the sound signals convey directionally encoded information with a resolution equal to first-order microphones (cardioid, figure-eight, etc.). In one example, an ambisonic system may use a specialized microphone array, called a SoundField™ microphone. One example of a SoundField microphone is a marketed under the brand name TetraMic™ from Core Sound LLC, Teaneck, N.J., USA. FIG. 1 shows an example of an image capture device 100 together with a TetraMic microphone array 102 which may be used to capture audio signals in the present system. Details of the image capture device 100 are set forth in the above-referenced Panoramic Imaging Application. Microphone arrays other than a SoundField microphone may be used in further embodiments. FIG. 1 also shows a computing device 104 coupled to both the capture device 100 and microphone array 102. Further details of an exemplary embodiment of computing device 104 are described below with reference to FIG. 12.

Reproduction of the B-format sound signals may be done using two or more loudspeakers, depending in part upon the required reproduction (2D or 3D). It is understood that more than two loudspeakers may be used in further embodiments. In one further embodiment, there may be 4 loudspeakers, and in a further embodiment, there may be 8 loudspeakers.

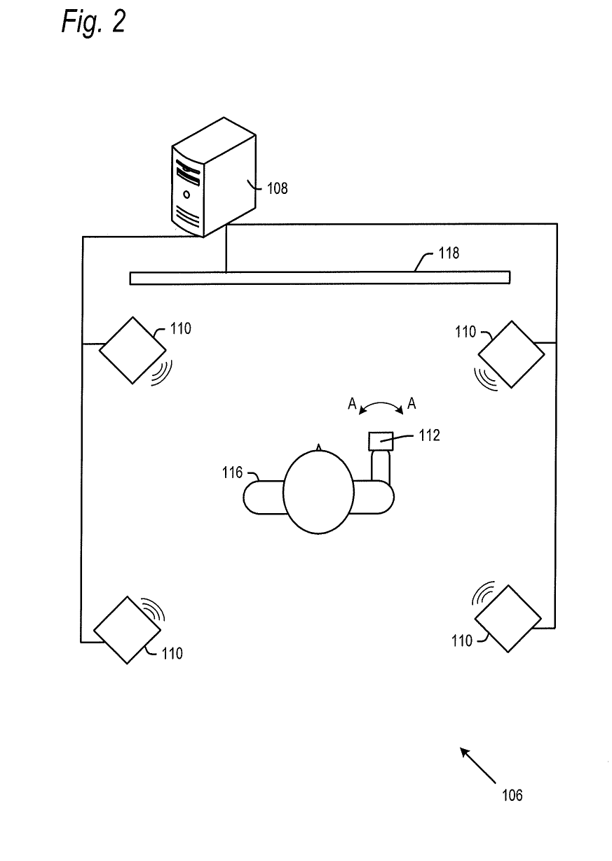

FIG. 2 is a top view illustration of a playback system according to embodiments of the present system. FIG. 2 shows a system 106 including a computing device 108, four loudspeakers 110, and a controller 112. All components are shown schematically. The controller 112 shown is a hand-held controller held by a user 114. However, in further embodiments, the controller may be head-mounted on the user 114. The user is viewing panoramic images on a display 118. In the description that follows, a reference space is defined where the z-axis is aligned vertically (perpendicular to the force of gravity), the y-axis is defined perpendicular to the z-axis and the display 118, and the x-axis is perpendicular to the z-axis and the y-axis.

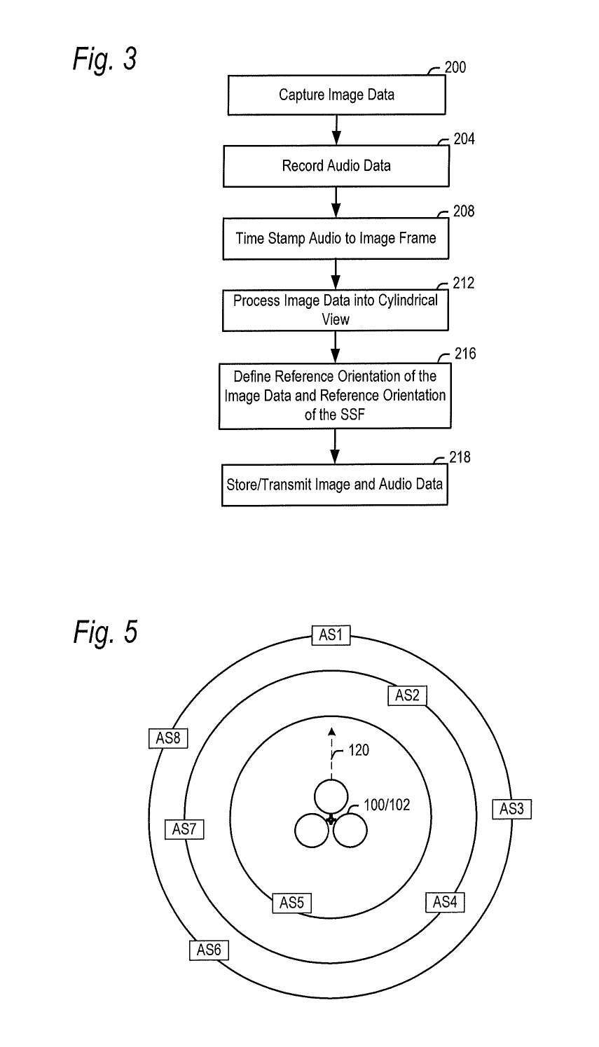

In operation, the user may manipulate the controller 112 by tilting it about x, y and/or z axes to control the panoramic images displayed on display 118. As one example, where the display 118 is perpendicular to the y-axis, the user may tilt the controller about the z-axis (along arrow A-A in FIG. 3) by a positive angle to affect clockwise rotation of the displayed image; that is, causing images of the panorama to move on the display from left to right. A tilt of the controller about a negative angle about the z-axis causes a counterclockwise rotation of the displayed image from right to left. Movement of the controller about other axes may affect movement of the image on the display 118 in corresponding ways about those axes.

The controller 112 may be a known device, including for example a 3-axis accelerometer and/or other sensors for sensing movement of the controller. The controller 112 may communicate with the computing device 108 via wireless communication protocols, such as for example Bluetooth. It is understood that the controller 112 may operate by other mechanisms to affect movement of the image in further embodiments.

Sounds recorded in ambisonic B-format using microphone array 102 of FIG. 1 may conceptually be placed either on the surface of a unit sphere, or within the sphere. The sound source coordinates obey the following rule:

(x²+y²+z²)<=1,

where x is the distance along the X, or left-right axis; y is the distance along the Y, or front-back axis; and z is the distance along the Z or up-down axis.

When a monophonic signal is positioned on the surface of the sphere, its coordinates x, y and z are given by:

x=(sin A)(cos B),

y=(cos A)(cos B), and

z=sin B,

referenced to the center front position of the sphere, where A is the horizontal angle subtended at the listening position, and B is the vertical angle subtended at the listening position.

These coordinates may be used as multipliers to produce the B-format output signals X, Y, Z and W as follows:

X=(input signal)(sin A)(cos B),

Y=(input signal)(cos A)(cos B),

Z=(input signal)(sin B), and

W=(input signal)(0.707).

The 0.707 multiplier on W is equal to the sin 45°, and gives a more even distribution of signal levels within the four channels. These multiplying coefficients can be used to position monophonic sounds anywhere on the surface of the sound field.

While embodiments of the present system described above and hereafter use ambisonic recording and playback of audio data, it is understood that other sound recording and playback systems may be used. For example, the present technology may be adapted to operate with other formats such as Stereo Quadraphonic, Quadraphonic Sound, CD-4, Dolby MP, Dolby surround AC-3 and other surround sound technologies, Dolby Pro-logic, Lucas Film THX, etc. A further discussion of the capture and playback of sound spatialization fields, by ambisonic and other theories, is provided in the following publications, each of which is incorporated by reference herein in its entirety:
Bamford, J. & Vanderkooy, J., “Ambisonic Sound For Us,” Preprint from 99th AES Convention, Audio Engineering Society (Preprint No 4138) (October, 1995);
Begault, D., “Challenges to the Successful Implementation of 3-D Sound,” Journal of the Audio Engineering Society, Vol. 39, No 11, pp 864-870 (1991);
Gerzon, M., “Optimum Reproduction Matrices For Multi-Speaker Stereo,” Journal of the Audio Engineering Society, Vol. 40, No 7/8, pp 571-589 (1992);
Gerzon, M., “Surround Sound Psychoacoustics,” Wireless World December, Vol. 80, pp 483-485 (1974);
Malham, D. G., “Computer Control of Ambisonic Soundfields,” Preprint from 82.sup.nd AES Convention, Audio Engineering Society (Preprint No 2463) (March, 1987);
Malham, D. G. & Clarke, J., “Control Software for a Programmable Soundfield Controller,” Proceedings of the Institute of Acoustics Autumn Conference on Reproduced Sound 8, Windermere, pp 265-272 (1992);
Malham. D. G. & Myatt, A., “3-D Sound Spatialization Using Ambisonic Techniques,” Computer Music Journal, Vol. 19 No 4, pp 58-70 (1995);
Naef, M., Staadt, O., Gross, M., “Spatialized Audio Rendering for Immersive Virtual Environments,” In Proceedings of the ACM Symposium on Virtual Reality Software and Technology, H. Sun and Q. Peng, Eds. ACM Press, 65-72. (2002);
Poletti. M., “The Design of Encoding Functions for Stereophonic and Polyphonic Sound Systems,” Journal of the Audio Engineering Society, Vol. 44, No 11, pp 948-963 (1996);
Vanderkooy. J. & Lipshitz. S., “Anomalies of Wavefront Reconstruction in Stereo and Surround-Sound Reproduction,” Preprint from 83rd AES Convention, Audio Engineering Society (Preprint No 2554) (October, 1987); and
U.S. Pat. No. 6,259,795, entitled “Methods and Apparatus For Processing Spatialized Audio,” issued Jul. 10, 2001.

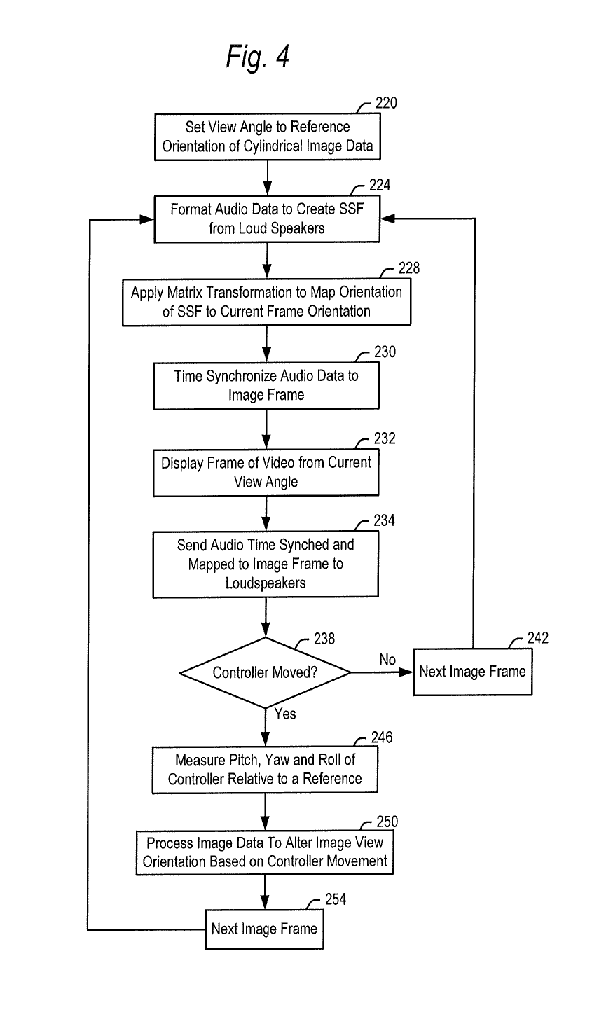

Operation of the present system for mapping of a recorded sound spatialization field to a recorded panoramic image will now be described with reference to the flowchart of FIGS. 3 and 4. FIG. 3 describes the capture of image and audio data and FIG. 4 describes the playback of image and audio data. Referring initially to the flowchart of FIG. 3, in step 200, the image capture device 100 captures images, and in step 204 the audio microphone array 102 records audio associated with the captured images. Audio is recorded by any of the above-described technology, such as for example on four channels in ambisonic B-format.

In step 208, the recorded audio data and captured frame of image data are time stamped. This will allow easy synchronization of the image and audio data when played back as explained below. In step 212, the captured image data is processed into cylindrical image data of a panorama. In one embodiment described in the above referenced Panoramic Imaging Application, the image data is processed into left and right cylindrical images which together provide a stereoscopic view of a panorama, possibly around 360°. In further embodiments, the computing device 104 may skip step 212 when the image data is captured and instead store the raw image data. In such embodiments, the raw image data may be processed into the cylindrical view of the panorama (stereoscopic or otherwise) at the time the image is displayed to the user.

In step 216, the computing device 104 (present but not shown in FIG. 5) defines a reference orientation of the image data and a corresponding reference orientation of the audio data. Step 216 is explained in greater detail with respect to the top view of FIG. 5. FIG. 5 shows image capture device 100 and microphone array 102 capturing image and audio data at a given instance in time. FIG. 5 and other figures show audio sources 1 through 8 at various angular orientations and distances from the device 100/array 102. There may be fewer or more audio sources, and some audio sources may not emanate from a discrete point. The audio sources AS1 to AS8 are shown by way of example only. Moreover, FIG. 5 and other figures show the audio sources at discrete orbital radii from the center. Again, this is by way of example, and different audio sources may be at any radius from the center in further examples.

FIG. 5 also shows only one planar view, for example perpendicular to the above-defined z-axis. The audio sources 1 through 8 similarly have an orientation to the device 100/array 102 relative to the x-axis and y-axis as well. The vector orientation of the audio sources 1 through 8 is known relative to the device 100/array 102, which may be defined as the origin (0,0,0) in Cartesian space.

When recorded, the sound spatialization field is aligned to the captured images in the device 100/array 102. That is, the capture device 100 is able to determine the vector orientation of an object, for example audio source 1 of FIG. 5, relative to the capture device. Similarly, the microphone array 102 is able to determine the same vector orientation of the audio source 1 relative to the microphone array. In step 216, the computing device 104 selects an arbitrary unit vector 120, for example 1, 1, 1 as the reference orientation relative to which other image data captured by the device 100 may be described. The computing device defines the same unit vector 120 for the sound spatialization field.

As explained below, when an image is initially displayed during playback of the image data, the system may initially position the unit vector between the user's head and the center of the display 118. Having also defined the same reference vector for the sound spatialization field, the field may initially map to reference vector during audio playback so that the sound spatialization field is initially correctly mapped to the displayed initial image. The image and sound spatialization field may thereafter be rotated in 3D space as explained hereinafter. The captured image data and recorded sound spatialization field may be stored and/or transmitted to another computing device in step 218.

After image and audio data has been captured by the capture device 100 and microphone 102, a user may experience the image and audio data at another time and place, from the data stored on the computing device 104 where the data was initially stored or from a computing device 108 which received a transmission of the data (computing device 108 is referred to in the following description). The operation of the system 106 for presenting this experience to the user is now explained with reference to the flowchart of FIG. 4. In step 220, the view angle of the image to be displayed is set as the reference orientation. Thus, the view angle of the image data may be set as described above so that the unit vector aligns to the center of the display.

In step 224, the audio data is formatted to recreate the sound spatialization field around the user via the loudspeakers 110. As explained below, a user may alternatively experience the audio using headphones or earbuds. In such embodiments, the data would be specifically formatted to recreate the sound spatialization field for those sound transmission mediums.

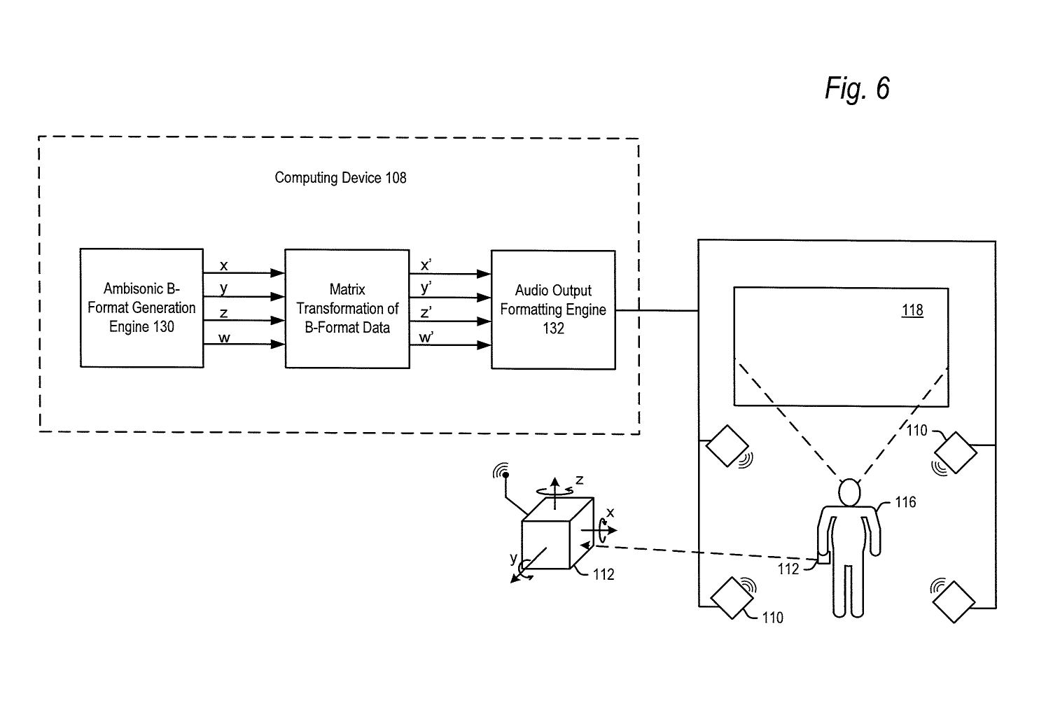

FIG. 6 shows a block diagram for the formatting of the audio data for broadcast over speakers 110. As noted above, in embodiments, the present system may format data as ambisonic B-format data. FIG. 6 is described with respect to this format. As noted above, the B-format channel information includes three microphone channels X, Y, Z, in addition to an omnidirectional channel W. Computing device 108 may include an ambisonic B-format generation engine 130 which generates B-format audio data in accordance with the standard including the four channels X, Y and Z.

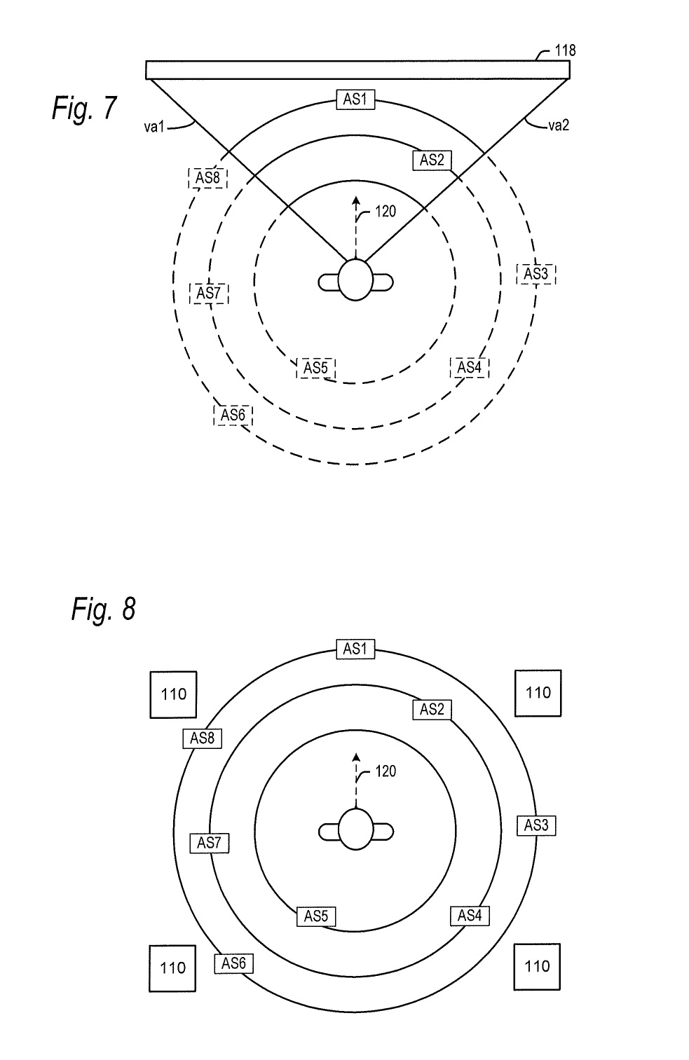

In step 228 (FIG. 4), the computing device 108 next applies a matrix transformation to map the orientation of the sound spatialization field to the current viewing angle at which the user is viewing the image data. In particular, the computing device 108 first determines the current orientation of the cylindrical image relative to the reference vector 120 (out from the user's head). When the image is first displayed (before the user has had an opportunity to change the viewing angle), the orientation of the cylindrical image will be at the reference vector 120. This situation is shown in FIG. 7. FIG. 7 shows only the view perpendicular to the z-axis; the views perpendicular to the x-axis and y-axis are not shown, but the following description applies equally. In FIG. 7, the initial display aligns the reference vector between the user's head and the center of the display 118. Objects (such as AS1 and AS2) falling within the viewing angle defined by lines va1 and va2 are visible on the display. Other objects of the panorama (AS3 through AS8) are not visible. Sounds from unseen objects however are still generated and played in the sound spatialization field that is recreated by speakers 110.

Referring now to FIG. 8, step 228 determines the orientation of the sound spatialization field in the reference space of the speakers 110 based on the current viewing position relative to the reference vector. In particular, the orientation of the current view position provides input to an orientation matrix OM which outputs the orientation of the sound spatialization field in the room reference space for the current view. The orientation matrix OM calculation may be given by:

$$OM = [ \begin{matrix}1 & 0 & 0 \\ 0 & cos ( roll ) & sin ( roll ) \\ 0 & - sin ( roll ) & cos ( roll )\end{matrix} ] \times [ \begin{matrix}cos ( pitch ) & 0 & - sin ( pitch ) \\ 0 & 1 & 0 \\ sin ( pitch ) & 0 & cos ( pitch )\end{matrix} ] \times [ \begin{matrix}cos ( yaw ) & sin ( yaw ) & 0 \\ - sin ( yaw ) & cos ( yaw ) & 0 \\ 0 & 0 & 1\end{matrix} ] ,$$

where yaw is the rotation angle about the z-axis of the current image, pitch is the rotation angle about the x-axis of the current image, and roll is the rotation angle about the y-axis of the current image.

Once the orientation matrix OM is calculated, it is possible to map the X, Y and Z coordinates of the computed B-format data for sound sources into an orientation matching the view orientation. In particular, with reference to FIG. 8, the location of audio sources AS1 through 8, corrected for the view angle, will be given by rotated B-format data X′, Y, Z′. This B-format data X′, Y′ and Z′ may be computed by multiplying the X, Y, Z B-format values for an audio source by the computed orientation matrix OM:

$$[ \begin{matrix}{X}^{′} \\ {Y}^{′} \\ {Z}^{′}\end{matrix} ] = [ OM ] \times [ \begin{matrix}X \\ Y \\ Z\end{matrix} ]$$

The omnidirectional channel for W may also be factored in:

$$[ \begin{matrix}{X}^{′} \\ {Y}^{′} \\ {Z}^{′} \\ {W}^{′}\end{matrix} ] = [ \begin{matrix} & & & 0 \\ & OM & & 0 \\ & & & 0 \\ 0 & 0 & 0 & 1\end{matrix} ] \times [ \begin{matrix}X \\ Y \\ Z \\ W\end{matrix} ]$$

Using this process, the position of all audio sources may be computed in room coordinates. Unlike the image data, where only those objects in the field of view are displayed, the full spherical sound spatialization field is produced from the loudspeakers, even for objects not appearing on the display.

Initially, where the image is displayed at the reference vector, the values for X′, Y′, Z′ and W′ will simply be the same as the B-format data values X, Y, Z and W for a given audio source. However, as explained below, as the image view is adjusted, the above matrix transformation will map the sound spatialization field to the adjusted view. Further detail with regard to mapping multiple audio sources in the sound spatialization field to view angle of the image is disclosed in U.S. Pat. No. 6,259,795, previously incorporated by reference above. A known software application applying an orientation matrix to re-orient a sound spatialization field is also commercially available under the brand name Rapture 3D from Blue Ripple Sound Limited, London, UK.

As noted above, the image data may be formed into cylindrical view of the panorama. In such embodiments, it is conceivable that the viewing angle only change with respect to rotation about the z-axis, with the displayed images remaining fixed with respect to rotation about the x- and y-axes. In such embodiments, the matrix transformation would alter only the z-axis orientation of the sound spatialization field, with the orientation of the field about the x- and y-axes remaining fixed. Rotation of the image about two axes or full three axes is also contemplated.

Referring now to step 230, the computing device 108 next ensures time synchronization between the image data and audio data. Further details of a suitable synchronization operation of step 230 are disclosed in applicant's co-pending U.S. patent application Ser. No. 12/772,802, entitled “Heterogeneous Image Sensor Synchronization,” filed May 3, 2010, which application is incorporated herein by reference in its entirety. However, as noted above, the video and corresponding audio were both time stamped when created. These time stamps may be used to ensure synchronous playback of the audio and video. Additionally, known gunlock and other audio/video synchronization techniques may be used.

In step 232, the current image frame is displayed to the user 116 on display 118. In embodiments, the display may be a television. However, in further embodiments, the display may be a head mounted display where the image of the real world is occluded and the user sees only the displayed image.

In step 234, the properly transformed, mapped and synchronized audio signal is converted to an output signal for the loudspeakers 110 to recreate the sound spatialization field around the user. In particular, as is known, the X′, Y′, Z′ and W′ components of the rotated B-format for each audio source data may be processed through one or more filtering elements of a formatting engine 132. As is known, these filtering elements may comprise a finite impulse response filter of length between 1 and 4 ms., though other filters may be used and for other lengths of time. The filtered outputs may then be summed together, converted from digital to analog signals by a D/A converter, and output to the loudspeakers 110. The conversion operation of step 234 is a known operation. Further details of step 234 are provided for example in U.S. Pat. No. 6,021,206, entitled “Methods and Apparatus for Processing Spatialised Audio,” issued Feb. 1, 2000, which patent is incorporated by reference herein in its entirety.

In step 238, the computing device 108 looks to whether the user has moved the controller 112. As indicated above, the controller has systems such as a three-axis accelerometer to determine when movement has occurred. If no movement is detected, the next image frame of data is retrieved from memory in step 242 and the system returns to step 224 to format the audio for that new frame as described above. If there is no movement of the controller, the computing device 108 will continue to process and provide video of the panorama from the same view angle, together with the mapped sound spatialization field.

On the other hand, if movement of the controller 112 is detected in step 238, the change in position of the controller about the x (pitch), y (roll) and/or z (yaw) axes is determined by the controller 112 and/or computing device 108. Movement of the controller 112 forward/back, side-to-side and up and down may also be tracked to affect a corresponding change in the view angle and sound spatialization fields. Systems are known for tracking the movement of the controller in six degrees of freedom, such as for example those available from Polhemus, Colchester, Vt., USA.

In step 250, once the change in position of the controller is determined, a corresponding change in the viewing angle of the image on the display 118 is affected. The process by which the image is changed upon controller movement to change the viewing angle to a new area of the panorama is known. However, in general, a rotation of the controller 112 will affect a rotation of the image about the z-axis. This will allow the user to pan around 360° of the panoramic image over time.

In embodiments, the sound spatialization field is mapped to adjusted orientation of the image data. In further embodiments, the sound spatialization field may be mapped to the orientation of the controller 112. In such embodiments, the pitch (x-axis), roll (y-axis) and yaw (z-axis) orientation of the controller 112 may be used as inputs to the orientation matrix OM, and the sound spatialization field adjusted accordingly upon a change in position of the controller.

Rotation of the controller about the x-axis may move the displayed image up or down on the display. And rotation of the controller about the y-axis may rotate the displayed image away from horizontal. As noted above, the system may alternatively ignore rotation of the controller about the x-axis and/or y-axis. In some embodiments, the system may only be sensitive to rotations of the image about the z-axis to pan the image left and right. Once the new view angle in the x, y and z orientations is determined in step 250, the next frame of image data at that view angle is retrieved from memory in step 254.

The flow then returns to step 224 to format the audio data for the current view angle. The ambisonic B-format data may be obtained as described above in step 224, and the transformation matrix may be applied to the B-format data as described above in step 228. As the image data has now been rotated about the x, y and/or z axes, the sound spatialization field will also undergo a corresponding rotation about the x, y and/or z axes so that the sound spatialization field remains mapped to the image data.

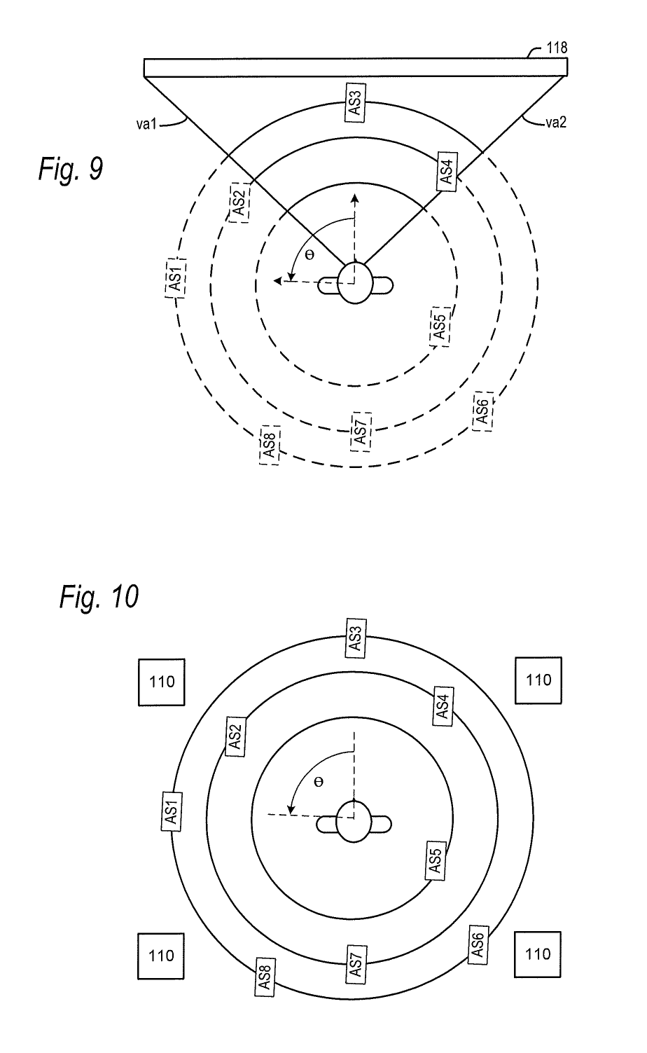

As one example, FIG. 9 shows a view perpendicular to the z-axis, where the user has manipulated the controller to rotate the panoramic view counterclockwise from right to left by an angle θ. In this view, the audio sources AS3 and AS 4 are visible on the display 118. By processing the B-format data in steps 224 and 228, the sound spatialization field undergoes the same rotation, as shown in FIG. 10. It is understood that similar mapping of the sound spatialization field to the image data may occur with respect to changes in the orientation about the x- and y-axes.

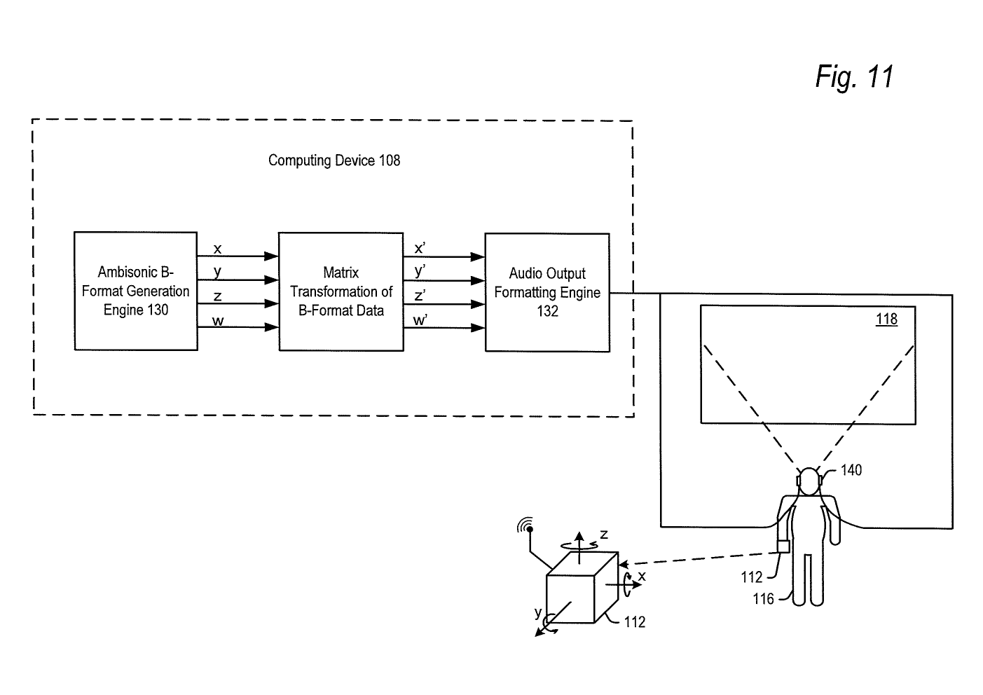

In the embodiments described above, the sound spatialization field, mapped to the image data, is recreated around the user 116 via loudspeakers 110. Though ambisonics or some other stereophonic or surround sound technology, the loudspeakers are able to create the impression of sound sources within the space around the user which were captured by the microphone array 102 around the captured panorama. In a further embodiment shown in FIG. 11, the sound is transmitted to headphones or earbuds 140. In this embodiment, the processing and/or matrix transformation of the ambisonic B-format data may be customized in a known manner for binaural presentation to the user 116. Such binaural processing of B-format data is performed for example by the Rapture 3D audio software application from Blue Ripple Sound Limited, London, UK, referenced above.

FIG. 12 shows an exemplary computing system which may be any of the computing devices mentioned above. FIG. 12 shows a computer 610 including, but not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 12 illustrates operating system 634, application programs 635, other program modules 636, and program data 637.

The computer 610 may also include other removable/non-removable, volatile/nonvolatile computer storage media. By way of example only, FIG. 12 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 12, provide storage of computer readable instructions, data structures, program modules and other data for the computer 610. In FIG. 12, for example, hard disk drive 641 is illustrated as storing operating system 644, application programs 645, other program modules 646, and program data 647. These components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 12. The logical connections depicted in FIG. 12 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 12 illustrates remote application programs 685 as residing on memory device 681. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. A method of mapping audio data of a real person, place and/or thing to image data of a panorama including the real person, place and/or thing, comprising:
(a) processing the image data of the panorama including the real person, place and/or thing to show the image data from a selected viewing angle; and
(b) processing audio data of the real person, place and/or thing to map a sound spatialization field of the audio data to align with the selected viewing angle of the image data.

2. The method of claim 1, wherein the mapping of said step (b) maps the sound spatialization field to the image data in three dimensions about three orthogonal axes.

3. The method of claim 1, wherein the mapping of said step (b) maps the sound spatialization field to the image data in a single, horizontal dimension.

4. The method of claim 1, wherein the mapping of said step (b) maps the sound spatialization field to the image data around 360° of one or more orthogonal axes.

5. The method of claim 1, wherein the processing of said step (b) is performed on ambisonic B-format data representing the sound spatialization field.

6. The method of claim 5, wherein the ambisonic B-format data is processed by transforming the B-format data using a computed orientation matrix receiving pitch, yaw and roll data from a viewing angle of the image data relative to a reference position.

7. The method of claim 1, further comprising the step of time synchronizing the processed audio data to the processed image data.

8. The method of claim 1, said step (b) of processing the audio data comprising the step of processing the audio data to recreate the sound spatialization field via loudspeakers surrounding the user.

9. The method of claim 1, said step (b) of processing the audio data comprising the step of processing the audio data to recreate the sound spatialization field via binaural sound transmission.

10. A system for presenting panoramic image data and associated audio data from a user-selected perspective, the image and audio data captured from a real person, place and/or thing, the system comprising:
a display for displaying images from the panoramic image data;
an audio transmitter for providing audio associated with the panoramic image data;
a controller for varying of the image data displayed on the display; and
a computing device for mapping a sound spatialization field to the panoramic image data so that the audio transmitted by the audio source matches an image displayed by the display.

11. The system of claim 10, wherein the audio transmitter is one of a plurality of loudspeakers and a binaural source sound transmission system worn by the user.

12. The system of claim 10, wherein computing device performs the mapping based on a determined view of the image data relative to a reference position of the image data.

13. The system of claim 10, wherein rotation of the controller about one or more of three orthogonal axes results in rotation of an image presented by the image data about one or more of the three orthogonal axes.

14. The system of claim 13, wherein computing device performs the mapping based on a determined orientation of the controller relative to one or more of the three orthogonal axes.

15. The system of claim 10, wherein the display is one of a television and a head mounted display.

16. The system of claim 10, wherein the audio data is processed in four channels according to the ambisonic standard.

17. A computer-readable storage medium for programming a processor to perform a method of mapping audio data of a real person, place and/or thing to image data of a panorama including the real person, place and/or thing, comprising:
(a) displaying a first image generated from the image data of a first portion of the panorama including the real person, place or thing;
(b) playing audio data to recreate a sound spatialization field aligned in three-dimensions with the image data of the real person place or thing;
(c) receiving an indication to change a viewing angle of the image displayed in said step (a);
(d) processing the image data to rotate an image displayed about one or more orthogonal axes;
(e) displaying a second image generated from the image data of a second portion of the panorama including the real person, place or thing based on processing the image data in said step (d);
(f) processing the audio data to rotate the sound spatialization field about the one or more orthogonal axes to the same extent the image was rotated in said step (d); and
(g) playing the audio data to recreate the sound spatialization field processed in said step (f).

18. The computer-readable storage medium of claim 17, wherein said step (d) rotates the image about a horizontal axis in response to the indication in said step (c), the sound spatialization field rotating about the single horizontal axis to the same degree.

19. The computer-readable storage medium of claim 18, wherein said step (d) rotates the image 360° about the horizontal axis in response to the indication in said step.

20. The computer-readable storage medium of claim 19, wherein said steps (a) and (d) display stereoscopic images of the panorama.
